(19) United States
(12) Patent Application Publication
(10) Pub. No.: US 2002/0048066 A1
(43) Pub. Date: Apr. 25, 2002

(54) Optical networking devices and methods for optical networks with increased transparency

(76) Inventors: Neophytos A. Antoniades, Leonia, NJ (US); Aleksandra Boskovic, Highland Park, NJ (US); Manish Sharma, North Brunswick, NJ (US); Eric L. Buckland, Hickory, NC (US); Douglas L. Butler, Painted Post, NY (US); Ming-Jun Li, Horseheads, NY (US); Thomas W. McNamara, Corning, NY (US); David A. Pastel, Horeseheads, NY (US); Mark J. Soulliere, Corning, NY (US); Michael J. Yadlowsky, Corning, NY (US)

Correspondence Address: CORNING INCORPORATED, SP-TI-3-1, CORNING, NY, 14831

(21) Appl. No.: 09/858,345

(22) Filed: May 15, 2001

Related U.S. Application Data
(60) Provisional application No. 60/204,165, filed on May 15, 2000.

(51) Int. Cl. H04J 14/02

(52) U.S. Cl. 359/128; 359/127

(57) ABSTRACT

A wavelength selective optical cross-connect includes a first demultiplexor feeding into individually removable modules that in turn feed a first multiplexor, such that the cross-connect is expandable and repairable on a wavelength or waveband basis. The modules desirably include multiple optical components in the optical path, with components in each module matched to others in that module to provide module-to-module variation below that of the variation in module components. The modules desirably include an additional demultiplexor and multiplexor. The modules also desirably include wavelength or narrowband amplification together with power equalization. The modules may also include a switch fabric. Alternatively, the switch fabric may be provided in the form of a separate removable switch module or modules, with various technologies employed in various switch modules, including manual switching with automatic connection discovery, with simple plug-in upgradeability to modules having automatic or remotely actuated switching.

This application claims the benefit of priority of the disclosure of U.S. Provisional Application No. 60/204,165, filed May 15, 2000, which is hereby incorporated herein by reference.

### FIELD OF THE INVENTION

This invention relates to devices and methods for use in optical communications networks and particularly to devices for use in optical networks having increased transparency, that is, increased distances over which the communication signals remain in optical form.

### BACKGROUND OF THE INVENTION

With explosion of demand for telecommunications bandwidth, the desirability of increasing the functionality and performance of the optical portion of the communications infrastructure has become well known. Increasing the transparency of optical networks can provide several benefits, including decreased costs, improved performance and upgradability, and increased flexibility for traffic management, protection (reliability), and provisioning.

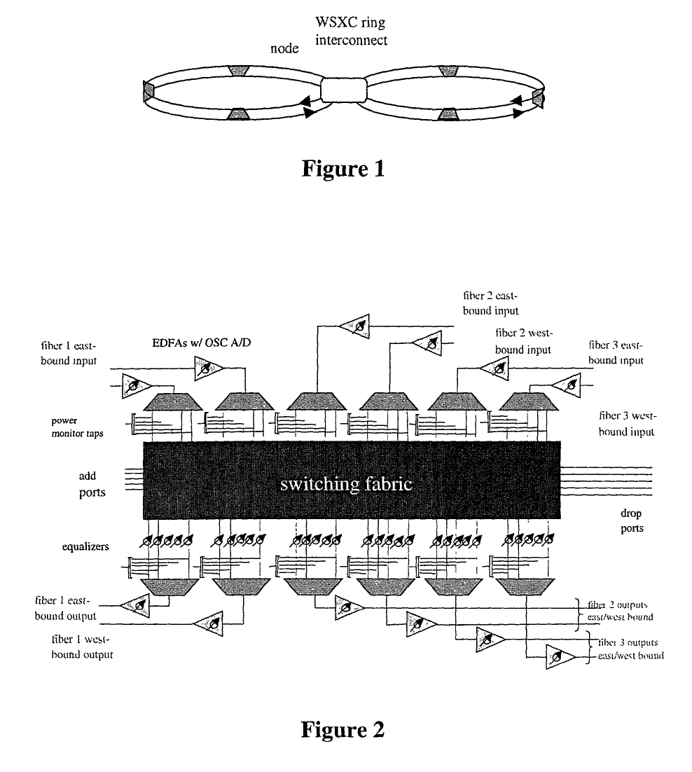

Optical fibers are frequently deployed in functional rings so that each node on the ring has at least two paths in or out. The rings, which provide path diversity for increased resistance to fiber cuts, are typically deployed in pairs allowing full duplex traffic. Wavelength selective cross-connects (WSXCs) can be used to interconnect one or more pairs of rings and further generate more complex network topologies with mesh or partial mesh connectivity, as shown in FIG. 1. A WSXC demultiplexes the wavelength channels carried on the input fibers, typically amplifies or regenerates them, then routes and multiplexes the signals destined for the same output fiber.

A WSXC consists of a large number of different optical components. Cost-effective provisioning and control of the various components is needed, particularly while maximizing optical signal quality and minimizing loss.

### SUMMARY OF THE INVENTION

### BRIEF DESCRIPTION OF THE DRAWINGS

### DESCRIPTION OF THE INVENTION

The generic optical components/functionality of a WSXC according to the present invention are shown in schematically in FIG. 2. As shown in FIG. 2, there are a large number of electronic and software components which are responsible for powering, controlling and managing the operation of the system and communicating with the next higher level of the network management system. The control function consists of dedicated electronics and perhaps embedded control software that actuate, monitor and/or stabilize the optical components. The management function is provided by a combination of electronic hardware and software that can perform local management of the control function (verifying functionality, fault recovery etc.) and can communicate with the network management system (NMS), providing both status information and executing state changes requested by the NMS or its subsidiaries.

The switching fabric can be considered in many ways to be the core of the WSXC since it performs the routing function. It is also currently the most immature technology of the main components in a WSXC. Indeed the deployment of wavelength routed networks is largely delayed by the lack of large, high performance, cost effective switching fabrics. And even as larger switch fabrics become increasingly available, there will be continued pressure to keep prices down.

One way to get the interconnect/routing functionality of a WSXC without employing remotely configurable switching fabrics such as MEMs, thermo-optic and free space deflected beam techniques (with the associated cost and performance issues) is to use a manual switching fabric. A manual switching fabric is based on a patch panel (connectors terminating fibers mounted on a panel which can be routed with connectorized patch cords) and can employ “connection discovery” features.

Connection discovery refers to a method by which the connections implemented by a fiber patch panel can be determined by a control system which resides, at least in part, within the patch panel itself. A variety of techniques could be used to determine the connectivity of the patch panel. For example, a wire, placed within the fiber patch cord, could be terminated on the fiber connectors. The fiber connectors on the patch panel would make electrical connection with the patch cord and conduct electronic communications across the wire to determine the implemented connection. For electronic communications to occur, one side of the patch panel would have to generate a signal coded to indicate the identity of the source connector (e.g. using a digital baseband signal, a specific frequency, etc.). Another method would be to use a duplex fiber connector for each single fiber connection. One of the fibers of the duplex patch cord could be used for the traffic-bearing signal and the other could be used for carrying a signal (e.g. from a low cost LED) from one side of the patch panel to the other. This auxiliary signal could be used for the purpose of determining the connectivity implemented in the manner of the electronic communication listed above.

While patch panels are widely used to route signals within switching offices, typically, they have not been used to determine wavelength routing in WDM networks. One reason for this is the difficulty in determining where the signal has been routed, and keeping the network management system aware of this information. The present invention solves this problem by adding connection discovery to the patch panel (this combination will be referred to as a manual switching fabric) and using the result to route wavelength signals in a WSXC. Thus one example embodiment of the current invention combines the use of a manual switching fabric and other optical components of the cross connect (i.e.—some combination or subset of wavelength demultiplexors, optical amplifiers, optical power monitors, channel power equalizers, etc.) with electronic control and management functionality, along with a software-mediated interface to the network management system.

For many applications, a manual switching fabric may not provide all of the functionality desired. In particular, the remote configurability offered by many optical switching technologies has the potential to speed up the provisioning rate of new connections in a network. Thus another example embodiment of the present invention includes, as a feature of a cross connect, upgrade capability for the switching fabric technology from a low cost manual switch fabric to a remotely configurable one (or more generally, the capability to choose among different switch fabric technologies for use within the cross connect). This upgrade or technology-choice capability can be implemented on a wavelength-by-wavelength basis, all wavelengths at once, or for pre-defined groups (bands) of wavelength channels. The first and last options allow the cross connect to have a switch fabric responsible for routing signals which fabric consists of both manual and remotely configurable modules. The switching technology in the modules can likewise be based on a mixture of different technologies. Modules of one technology can be interchangeable with modules of a different technology.

There are two major benefits of building a cross-connect or WSXC using a modular/upgradeable switch fabric as discussed here. First, it would allow the user of the device to choose among multiple technology options for each wavelength or band. Second, a single basic WSXC design can be used for a wide variety of applications.

The switch fabrics needed for crossconnects with low connectivity (a small total number of fiber going in and out, such as might be encountered where only two rings are being interconnected) are naturally much smaller than those needed for high connectivity nodes (where a large number of rings are interconnected). The value of both is these is primarily driven by cost. Currently the cost of a remotely configurable switch fabric significantly exceeds that of the manual switch fabric. Furthermore, the cost of a remotely configurable switch fabric typically increases rapidly with size. Therefore, with the crossconnect presented here, a carrier could first employ a manual switch fabric in order to enjoy the cost savings of using a transparent network and get most of the functionality of a WSCX without having to pay for an expensive remotely configurable switch fabric. As the price of remotely configurable fabrics decreases or traffic patterns change (for example, as churn becomes an issue for wavelength services), the manual switch fabric can be upgraded to a remotely configurable switch fabric based on the appropriate technology. Furthermore, by allowing the upgrade to be done on single wavelengths or bands consisting of less than the total number of wavelengths carried by the fiber, this upgrade can be done with minimal impact on existing traffic.

One way to construct a crossconnect according to an example embodiment of the present invention is to separate the switching function to individual ‘wavelength planes.’ Since transparent crossconnects do not have inherent wavelength conversion capability, there is no need to be able to route a particular wavelength to the multiplexer port of any other wavelength. Once a means of grouping like wavelengths is implemented, a modular switch fabric construction can be used. In order to facilitate upgrade of the switch fabric, the wavelength-plane switch modules can be connectorized to facilitate their deployment as needed and/or their upgrade to another switch fabric technology.

Wavelength conversion, if desired, can be implemented using opto-electronic transponders in a WSXC that has add/drop capability on each wavelength by dropping a signal, changing wavelength with the transponder, and then adding the new signal.

Some of the significant features of these examples of the invention include: (1) a WSXC with manual switch fabric patch panel with connection discovery for wavelength routing; (2) a WSXC with a switch fabric that is replaceable, and deployable and upgradeable, wavelength-by-wavelength or band-by-band; (3) a WSXC in which the routing of different wavelengths uses different switch fabric technologies (including a manual switch fabric, for example); and (4) a manual switch fabric which has a controller or other interface which can communicate with the element/network management system and convey information regarding signal routing

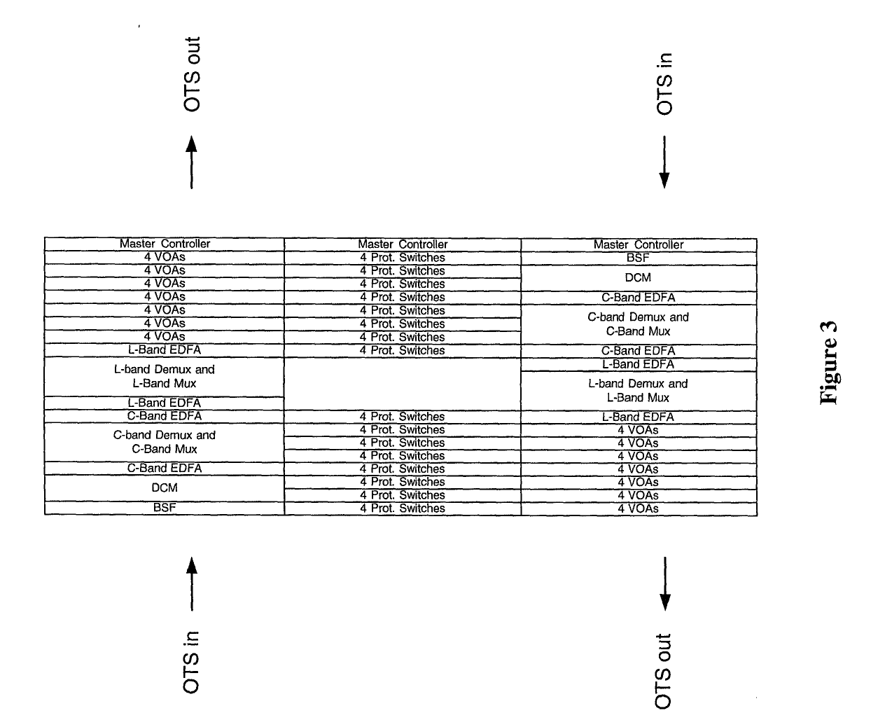

In order to facilitate the modularity of the cross-connect design, the entire system can be divided into several key units. The first unit, the optical transport section (OTS) or optical multiplex section (OMS), strips the overhead supervisory channel out from the incoming signal(s) and demultiplexes the signal into individual wavelength channels. It also can provide independent ring protection allowing the system to tolerate protection switches on each ring. An optical power equalizer can be used before the multiplexers that recombine the individual wavelength channels for eventual transport to the next network node. FIG. 3 shows an example rack layout for an example OMS section (in the form of an OMS shelf) of the crossconnect for use in both the C- and L-bands, as well as the components necessary for converting the OTS into an OMS.

In FIG. 3, the OTS signal enters a band-splitting filter (BSF), which removes the optical supervisory channel (OSC). The OSC is used for control, messaging, and alarming between nodes. The remainder of the signal (the OMS signal) may connect (via either a backplane or front panel connection) to an optional dispersion compensation module (DCM), and then back to the BSF module. This allows the dispersion to be compensated for the entire OMS. Alternatively, narrower band dispersion compensation can be performed later, after the signal has been split into smaller wavelength groups (called bands) in modules such as the EDFAs. The OMS can be split into two or more wavelength bands to aid amplification. In the present example, two bands are used: the C-band (approximately 1530-1560 nm) and the L-band (approximately 1565-1605 nm). The two signal groups are routed to appropriate amplifier modules via backplane connections. The amplifiers boost the signal power and then the signals connect through the backplane to the demultiplexor/multiplexor (DEMUX/MUX) modules.

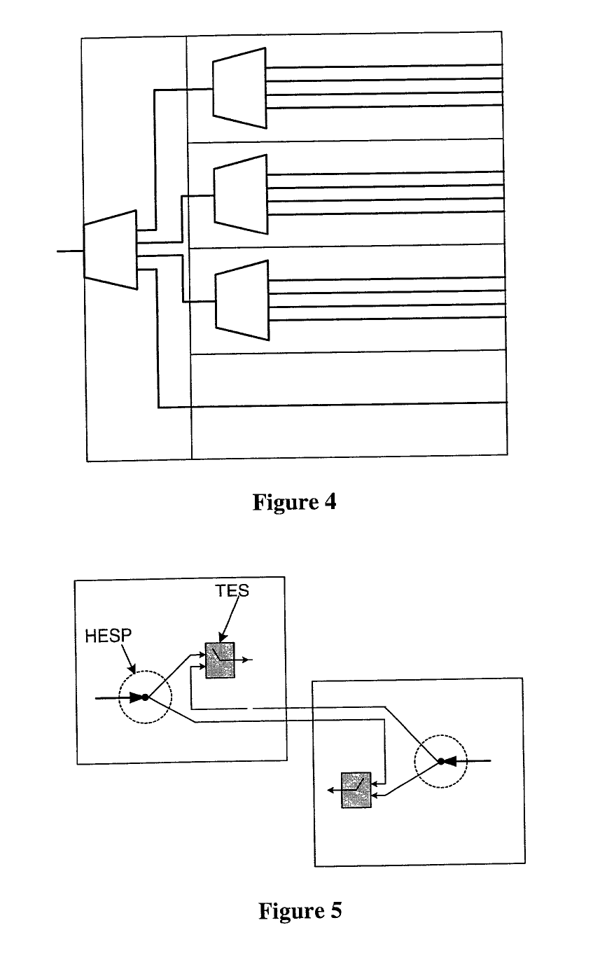

The demultiplexing portion of these modules separates the two bands into even finer wavelength bands which, in this example, consist of 4 wavelengths. If a banded wavelength structure such as this example is used, then the demultiplexor can be composed of a cascade of smaller demultiplexors, where the first one separates the signal into several wavelength bands, and the second set of demultiplexors further separate each band into its constituent wavelengths. FIG. 4 shows a rough schematic for a banded DEMUX or MUX module consisting of a maximum of 4 bands, where only 3 of the 4 bands are currently populated. The demultiplexor for each band is individually removable. This banded module approach has the advantage that only the demultiplexors for the bands used are initially purchased and deployed. When additional bands are added to the system, the demultiplexors are added to the module without disturbing any of the current connections. Note that any band structure can be used—i.e., both the number of wavelengths in a band and the number of bands can change, and the DEMUX/MUX module can still be structured in a similar modular fashion.

An alternative to a banded demultiplexor is to have all the wavelengths demultiplexed at the same time. This has a higher initial cost if the not all the wavelengths are going to be used in the system. The module would then be a monolithic demultiplexor, and in the example shown in FIG. 4, the system would have 16 output channels. As new wavelengths were added, additional connections could be made to the module without disturbing the existing traffic.

The individual channels can be connected either to a protection switch module if independent ring protection is desired, or directly to a wavelength interconnect/routing module, called the “shuffle shelf” module.

An example embodiment of a protection switch module includes a head-end splitter (HESP) and a tail-end switch (TES) is shown schematically in FIG. 5. For protection switching, two modules (one from East and one from West) are connected in the fashion shown in FIG. 5. The inputs to the protection switch modules are the signals from the East and West wavelength channels, and the outputs are connected to the East and West “shuffle shelf” modules.

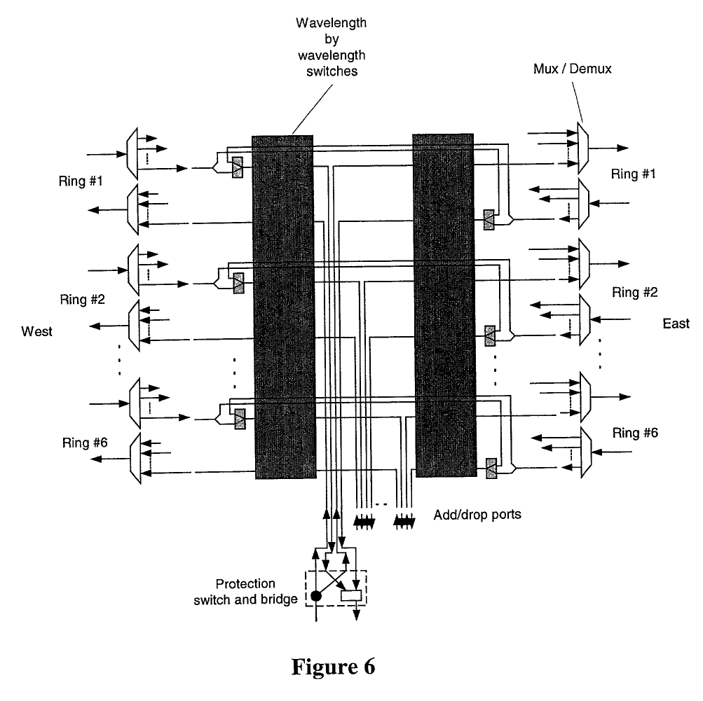

FIG. 6 shows a schematic that functionally indicates how the protection switches may be connected to each other and to the switching fabric. Note that the shuffle shelf is not shown here and also that the add/drop port optical protection is optional, depending on whether or not electrical protection switching is employed. The ring protection switches can also be mounted modularly, so that several switches plug into a motherboard module similar to the design used in the demultiplexor/multiplexor module. The protection switch modules shown in FIG. 6 have four switches per module assuming four wavelengths per band, but that number could be dependent on the band structure used (if any).

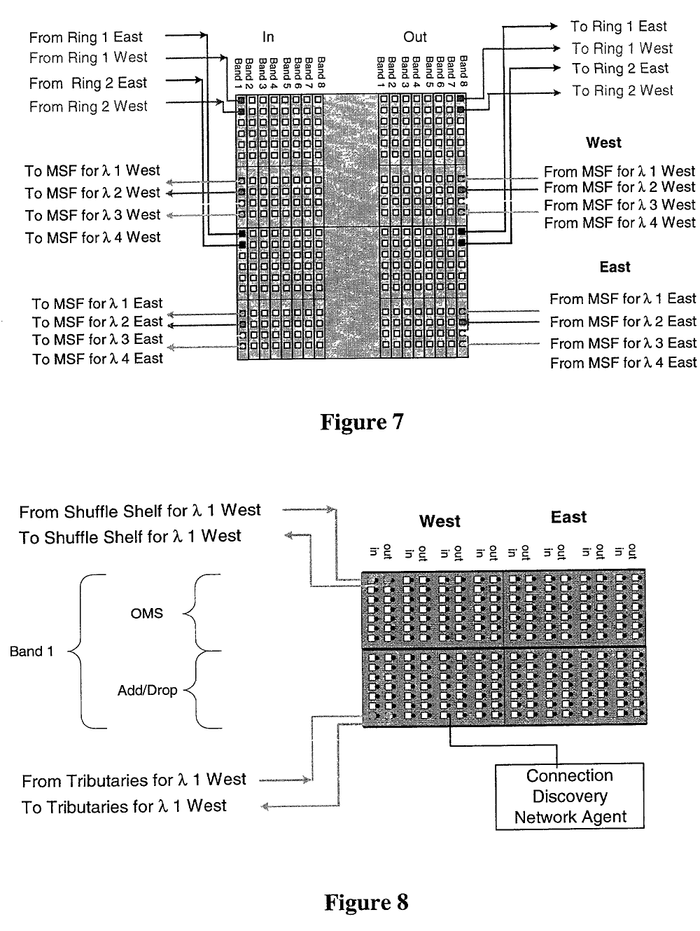

The shuffle shelf serves to reorganize the all the signals from an OMS ring structure to a wavelength plane structure. For example, if the network topology had 6 fiber rings connected by the WSXC, and also employed 8 fiber bands with 4 wavelengths per band, then an example shuffle shelf would be as shown in FIG. 7. In this example embodiment, the bulkhead connectors for the shuffle shelf module are array fiber connectors, and the signals in and out of the OMS ring are 4-fiber ribbon cable (in general, for example, one fiber for each wavelength in the bands used in the DEMUX/MUX) and each carries a complete band for a particular ring. The signals traveling from the shuffle shelf to the switching fabric are 6-fiber ribbon cables (in general one fiber ribbon cable for each of the ring pairs which are being interconnected), where each carry the same wavelength, one fiber from each fiber ring. Thus, the switching fabric (manual or remotely reconfigurable) can perform the necessary routing functions and the signals return to the shuffle shelf to be reorganized back into a per ring basis.

The physical mechanism and function of the shuffle shelf can be performed by several different methods. For example, a flexible optical backplane could be employed, or several ribbon fiber fanouts spliced appropriately could be used. Note that the exact form of the shuffle shelf would vary depending on the wavelength band structure used, and would still be feasible even if no wavelength band structure was used. Also, the modularity of the shuffle shelf allows additional wavelengths to be added without disturbing existing traffic.

The manual switching fabric can also be arranged on a per wavelength or per band basis. FIG. 8 shows one configuration for the manual switching fabric (MSF) for a 6-ring fiber network topology that groups the connections on a per wavelength basis. In the case where a band consists of 4 wavelengths, a single shelf provisions an entire band (both East and West). By arranging the MSF in this manner, all front plane jumper connections needed to route signals localized sections of the patch panel. This simplifies fiber routing considerably. Also, all of these connectors desirably have some form of connection discovery incorporated into them, so that all connections are verifiable by the network software agent, which is shown schematically on the diagram. The tributaries listed in FIG. 8 are the local added and dropped wavelengths for the particular node in a ring.

This configuration allows for easy upgrade to a reconfigurable switching fabric (RSF) on a per wavelength or per band basis. For example, if a user wanted to upgrade a single wavelength to a RSF, then the system would temporarily be switched to protection ring and the fibers for the working ring would be routed to the RSF. Then the system would be switched back to working and the protection ring would be upgraded. Thus, a network system configuration could have some wavelengths or bands employing a manual switch fabric while other wavelengths could use a remotely reconfigurable switch fabric.

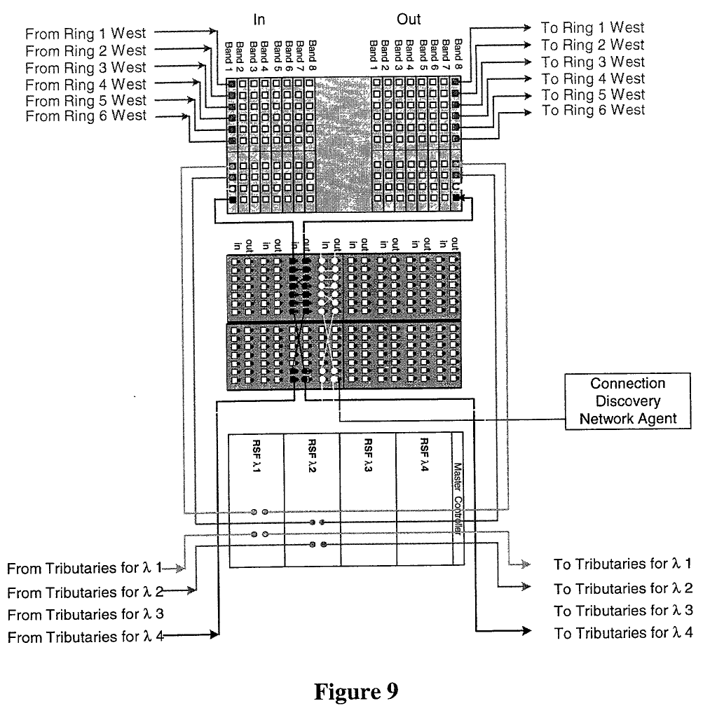

FIG. 9 shows an example schematic for a system with mixed types of switching fabrics. The network topology is 6 fiber rings, with the connections for a single 4 wavelength band being shown. Two of the wavelengths are routed through the MSF, while the other two are connected through two RSFs. Note that the switching technologies for the two RSFs do not have to be identical.

Following the signal path from the switching fabric(s), first, the signal returns to the shuffle shelf, and then back to the OMS shelves. Then, the signals can be connected to power equalization modules (PEQ) as needed on a per wavelength basis. The PEQ modules can also be modularly engineered so that several submodules independently plug into a motherboard. From the PEQ modules, the optical channel signals are routed to the multiplexor portion of the DEMUX/MUX module. The multiplexed signal connects via the backplane to the optical amplifiers, and then the C-band and L-band signals are recombined in the BSF. Lastly, in the BSF, the OSC signal is added to the OMS signal and the OTS leaves the WSXC.

Reducing the Complexity of Switch Fabrics

By separating the functionality of the switching fabric and the protection switches, it is possible to reduce in the size of switching fabrics needed for certain connectivity requirements. Also, by limiting the types of inter-ring connections supported in the WSXC, additional reductions in the cost and size of the switching fabrics can be realized. For example, fast switches are needed only for protection in many applications. Switch fabrics for routing signals typically have to be large (compared to the minimum size for a ring protection switch) but can be slow, in many cases, including manual switch fabrics in which routing is done by moving fiber jumpers or patch cords. Also, separating protection switching and signal routing switching makes it possible to use redundant switch fabrics (for many applications) and thus avoid having a single point of failure within the cross-connect.

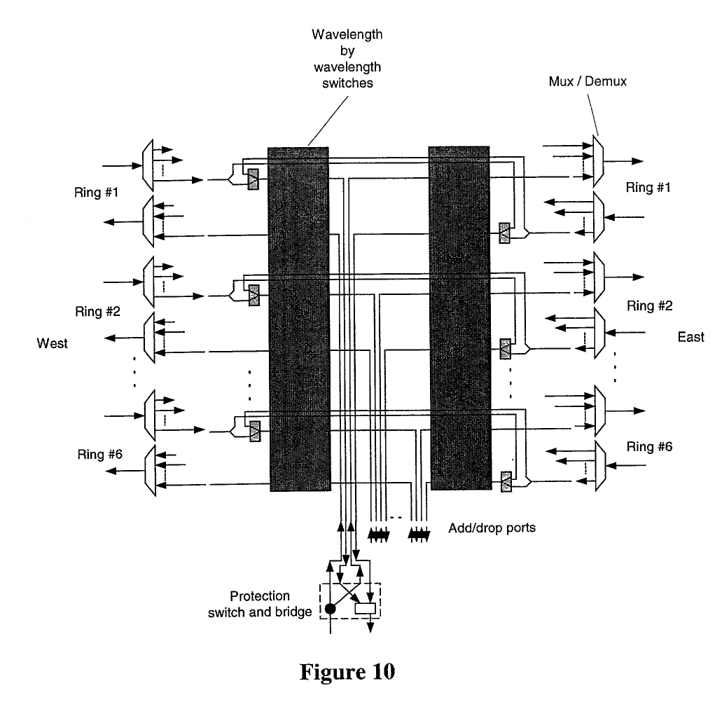

Take, for example, a WSXC for a WDM network system with independent ring protection (the ability to sustain protection switches on each ring traversed by a connection when using dedicated or 1:1 path protection). The network topology in this example consists of 6 interconnected two-fiber rings (for a total of 12 simplex fibers). The WSXC also has the capability of locally adding and dropping any or all of the wavelengths in the system. By breaking up the system into wavelength planes, separating the routing (working) and the protection switches, and routing working and protection (or east and west) traffic to separate, redundant switches, only 2 12×12 switches are necessary per wavelength to provision this system. This design, which can be readily scaled to other sizes, is shown schematically in FIG. 10. Note in FIG. 10 that the functionality of the local (client) add/drop port optical protection may alternatively be supplied electrically.

One major advantage of separating the protection switching from the signal-routing fabric is the reduction in size of the requisite switch fabric. Another advantage arises because different requirements exist for the two functions performed. Protection switching requires relatively fast switches with response times on the order of 10 ms, whereas the switching fabric switch time can be up to two orders of magnitude slower. This allows different technologies to be employed in the two switching functions, and greatly relaxes the performance requirements of the switching fabric.

Switch fabrics of this size can be constructed out any number of technologies. Monolithic 2D technologies, such as MEMS or planar thermo-optic switches can provide these types of switches, or mechanical switches employing stepper motor technology can make switches of this size. One more method is to create the switch by cascading smaller switch elements, such as combinations of 1×2 or 2×2 switches, although for switch fabrics of this size the number of elements needed generally makes cascading smaller switches a less attractive option.

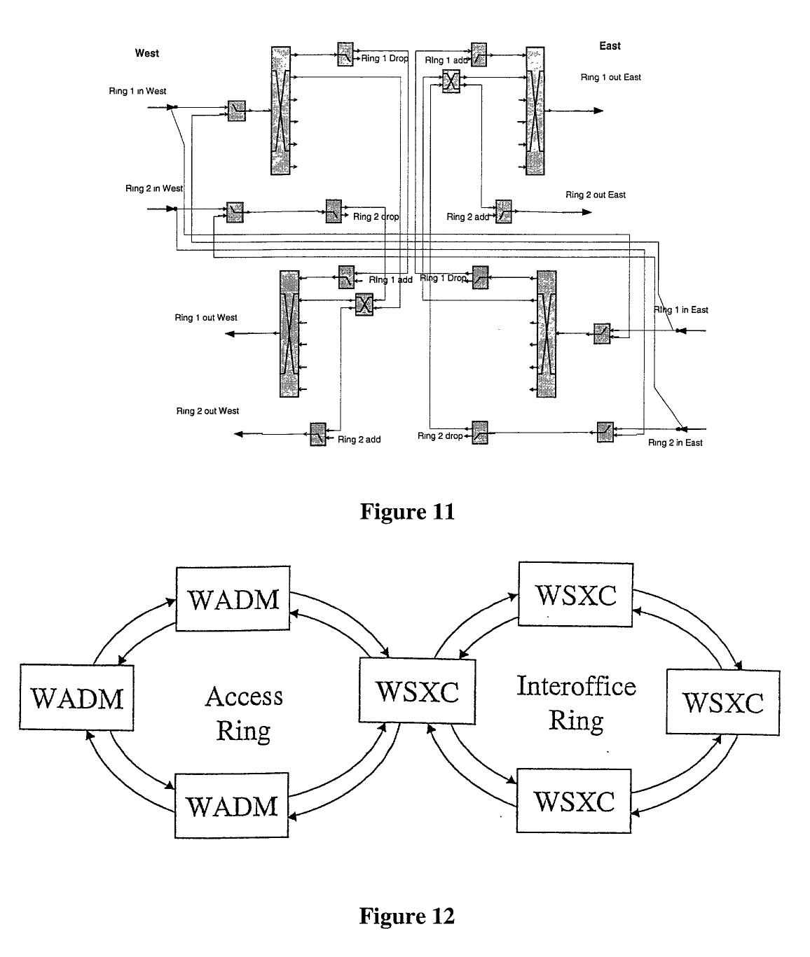

Another method for reducing the size of the switch fabric is limiting the connectivity of the WSXC. In the case where one of the fiber rings requires connectivity to all other rings, but the other rings only connect to themselves or the first ring, the switch fabric can take the form shown in FIG. 11, in which full details are shown for only two of the six rings. In the case of our six-ring example, this corresponds to one ‘access ring’ cross-connected to another ring which consist of a set of 5 overlaid fiber rings. This switch fabric shown in the example requires fewer switch elements or cross-points than the corresponding fabric that provides full connectivity. Furthermore, the reduced switch fabric and can easily be built out of smaller switches with a modular construction that allows other fibers rings to be added to the network by simply adding components to the existing switch fabric. This is a big advantage over the full connectivity case, where adding another fiber ring may require either the purchase of all new switching fabrics of a larger size, or the up front purchase of a large switching fabric.

In the case of such partial connectivity, the only component where it may be desirable to initially purchase a large device is the 1×N switch. Even that can easily be made modular (at the price of a slightly higher insertion loss) by cascading one or two levels of smaller switches. For example, a 1×6 can be made out of 1 1×3 and 3 1×2 switches, and so initially for a 2 fiber ring network topology, only the 1×3 and 1 1×2 would need to be purchased, and two more fiber rings could be added for each additional 1×2 used. Also, the existing traffic would not be affected during the upgrade, which wouldn't be true in the case where entire switch fabrics are being replaced.

Ring Based Optical Management Communication

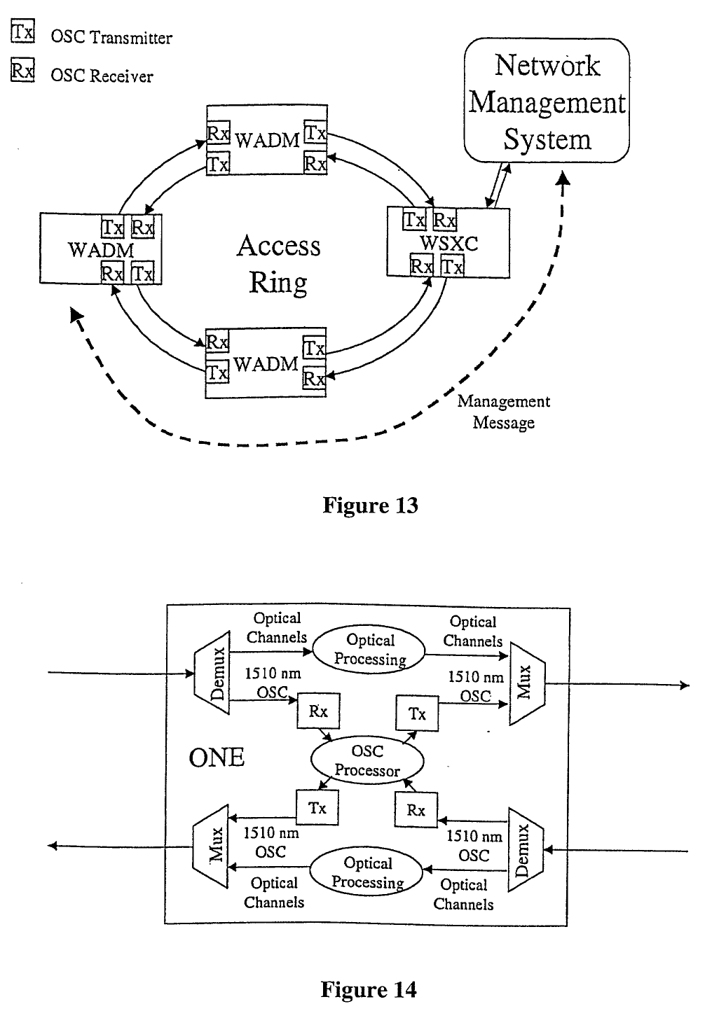

An optical network element (ONE) can be categorized as a piece of transmission equipment that transports multichannel optical signals. Examples of ONEs are wavelength terminal multiplexers (WTMs), wavelength add-drop multiplexers (WADMs), and optical cross-connects (OCXs). One type of cross-connect, a wavelength selective cross-connect (WSXC), in one example application, interconnects two optical rings—an access ring and an interoffice ring. This is shown, for example, in FIG. 12. Point-to-point WDM standards as well as emerging Optical Transport Network standards call for the use of an Optical Supervisory Channel (OSC) between each optical network element. The standardized wavelength for this OSC is 1510+/−10 nm. The OSC is used to send and receive a signal that includes management messages on the performance of the span and relayed messages from a network management system. This is illustrated for an access ring in FIG. 13.

For a typical implementation of a WADM, or a WSXC, an incoming OSC signal must be: demultiplexed from the bundle of Optical Channels; converted to an electrical signal for processing; recreated as an outgoing OSC; and multiplexed back with the transmission signals (i.e. the Optical Channels). An example of this is shown in FIG. 14. The Optical Channels passing through an optical network element on a ring get attenuated by the OSC demultiplexer and the OSC multiplexer components.

An Optical Channel being added onto the ring, passing through K optical network elements, and then being dropped from the ring experiences a loss L due to the presence of the Optical Supervisory Channel, where

L=(K+1)×L_{MUX}+(K+1)×L_{Demu} (1)

It is desirable to support a ring with up to 8 nodes (K=6) or more. Assuming a worst-case OSC multiplexer loss of 0.5 dB and a demultiplexer loss of 0.5 dB, this adds up to 7.0 dB loss around a ring due to the presence of an OSC. If a splice loss of 0.2 dB per device is included, the loss around a ring due to the OSC increases to 9.8 dB. Smaller losses are desirable.

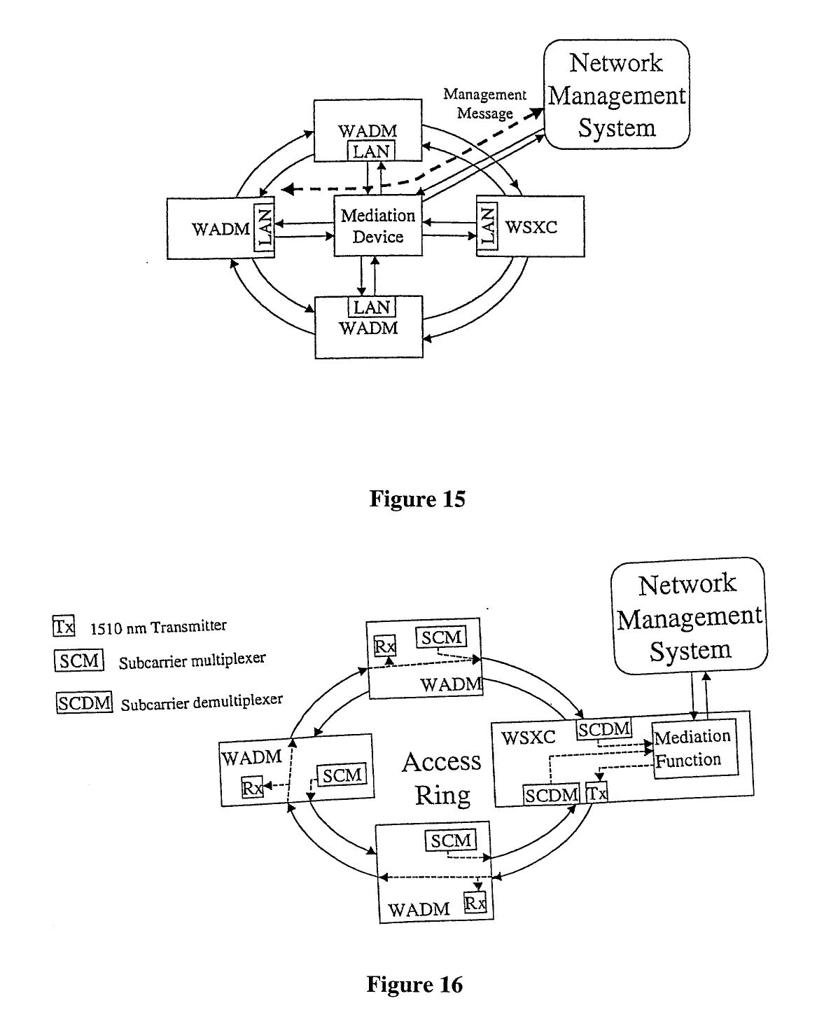

One way to achieve smaller losses and still provide network management communications is to use a mediation device such as shown in FIG. 15.

Instead of the ring nodes using an OSC for management messaging, each ring node has a separate interface to a mediation device. The mediation device receives inputs from all the ring nodes as well as the network management system (NMS), and directs the messages to the appropriate ONE or NMS. The mediation device may employ a local area network (LAN) interface. The advantage of this approach is that the optical channels incur no loss from the presence of an OSC. The disadvantage is that the ring nodes must each support a LAN or other interface. If this interface is electrical, then the ring size may be constrained by the transmission distance of the interface. If the interface is optical, then each ring node requires an additional fiber pair (as well as a transmitter and receiver).

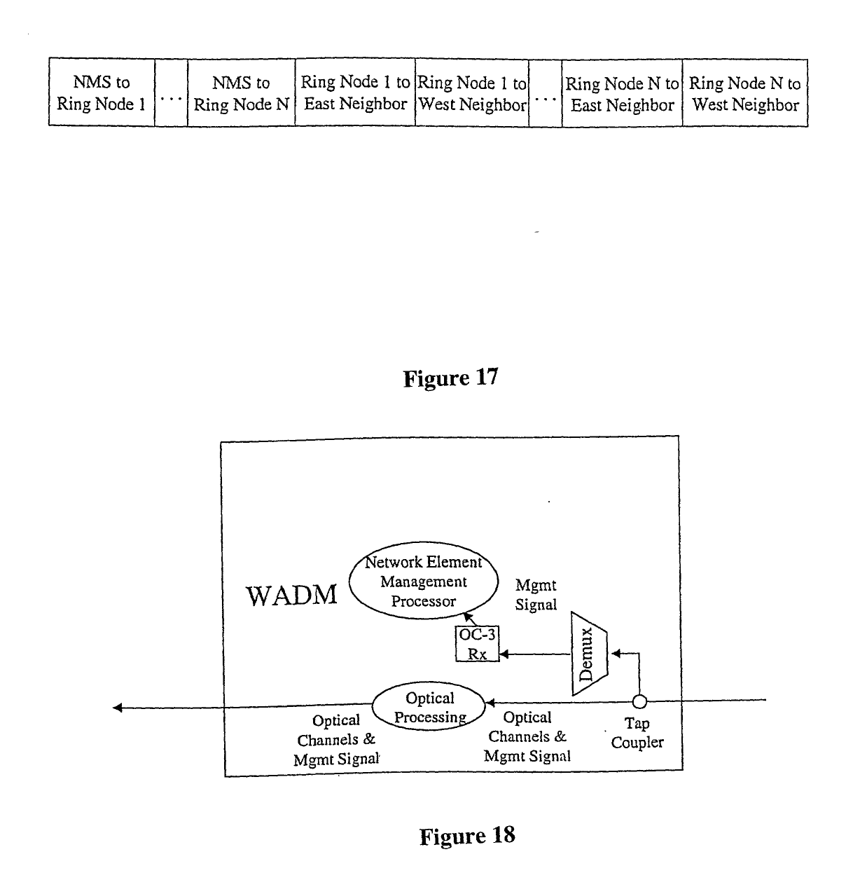

Another way to provide for network management communications with smaller losses is to place the mediation device functionality within the WSXC, and find an economical and loss-conscious way of transmitting to and from this mediation function. An embodiment is shown in FIG. 17.

All management messages from the mediation function to the WADMs are logically placed into an optical signal outside the transmission band of the Optical Channels (e.g. 1510 nm), and this signal is broadcast in one direction around the ring. Each WADM taps off a portion of this signal, converts it to an electrical signal, and processes the messages that are logically directed to it.

All management messages from the WADMs back to the mediation function are transmitted via subcarrier modulation (SCM). An Optical Channel being added at the WADM is overmodulated by a relatively lower frequency carrier tone, which in turn carries digital data. Each WADM overmodulates a different Optical Channel at a different SCM frequency. A portion of the Optical Channels' signals is tapped at the WSXC. Since an Optical Channel may operate unprotected on the ring and travel in either direction (clockwise or counterclockwise), the WSXC desirably can tap subcarrier modulated signals from either input fiber. Digital signal processing is performed at the WSXC to decode the various SCM signals, which are then fed into the mediation function.

All management messages between the mediation function and the WSXC proper are transmitted internally within the WSXC (e.g., via an electrical backplane).

Messaging from Mediation Function to WADM

The messaging from the mediation function to a WADM can go as follows. The bit rate of what is termed the “downstream management signal” is selected so as to be able to support all the messages among the ring nodes and the network management system. A 155.52 Mb/s SONET OC-3 signal, for example, is likely sufficient. The downstream management signal can be logically divided to at least include messages from the network management system to any ring node, and from any ring node to its nearest neighbors. This is illustrated in FIG. 17. The downstream management signal may be transmitted at the WSXC as shown in FIG. 16.

The downstream management signal is received at a WADM on the ring as shown in FIG. 18. The downstream management signal and the Optical Channels arrive at the right of the figure, and a small amount of the incoming signals is tapped off. The downstream management signal is demultiplexed from the tapped-off light, converted to an electrical signal and processed by the local network element management processor. The rest of the incoming signal is processed for the needs of the Optical Channels. This processing desirably incurs no significant power loss for the downstream management signal.

For example, a conventional long-haul SONET/SDH transmitter at 155.52 Mb/s can be expected to have a worst-case end-of-life average power to −5 dBm. Assuming, for example, that the downstream management signal has to cross 7 spans, each with a loss of 1.8 dB (2 km of fiber at 0.4 dB/km plus 2 connectors at 0.5 dB), the management signal also passes through 6 intermediate tap couplers, each with a loss of 0.18 dB (4% coupler). The final tap coupler introduces 14.0 dB of loss, followed by an optical demultiplexer with 0.5 dB loss. The signal power at the receiver is then −33.2 dB, which is well within the worst-case end-of-life range of a SONET OC-3 receiver.

An Optical Channel being added onto the ring, passing through K optical network elements, and then being dropped from the ring in this implementation experiences a loss L due to the management messaging system, where

L=(K+1)×L_{Tap}+L_{SCMpenal} (2)

For a ring with up to 8 nodes (K=6), a worst-case optical tap loss of 0.18 dB and a subcarrier multiplexing penalty of 1.0 dB, this adds up to 2.3 dB loss around a ring due to this implementation of management messaging. The comparable loss using an OSC implementation was 7.0 dB.

Messaging from WADM to Mediation Function

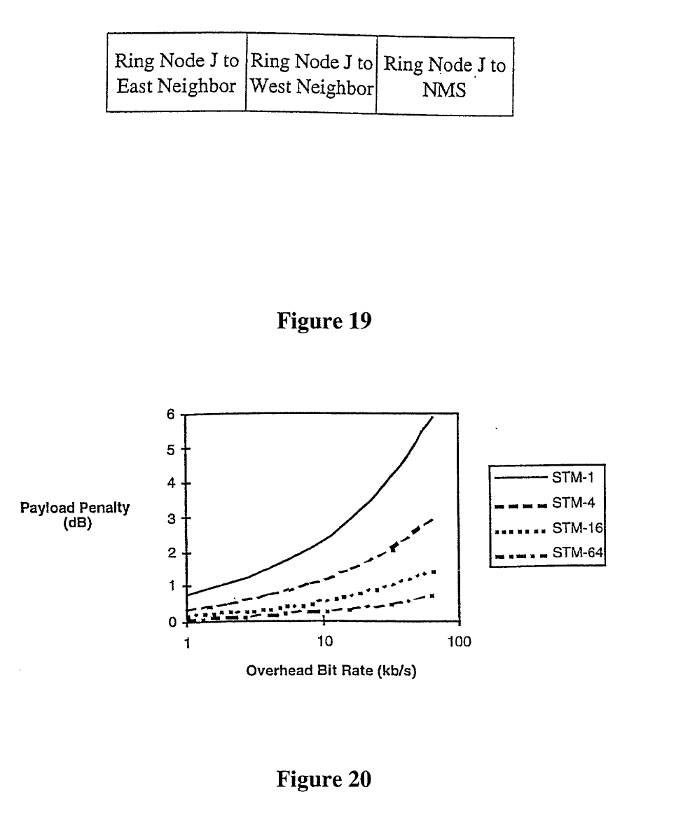

The messaging from a WADM to the meditation function can go as follows. First, the “upstream management signal” desirably at least supports messages from that node to its nearest neighbors, plus to the network management system. An illustration of this logical structure is shown in FIG. 19.

The bit rate to be used is constrained by what subcarrier modulation can support. A standards proposal from Nortel (Philippe Neusy, Nortel Networks, “Subcarrier Modulation of Client Signals: Implementation Issues,” TIA FO 2.1.1 standards contribution FO211-98-09-TD06 [also T1X1.5/98-122], Sep. 22, 1998) indicates that SCM induces a penalty on the Optical Channel that is dependent on the bit rate. This is shown in FIG. 20. To keep the induced penalty below 1 dB, for example, means that a 622.08 Md/s OC-12 (STM-4) signal can have an SCM channel bit rate of 10 Kb/s. This increases to 50 Kb/s for a 2.5 Gb/s OC-48 signal.

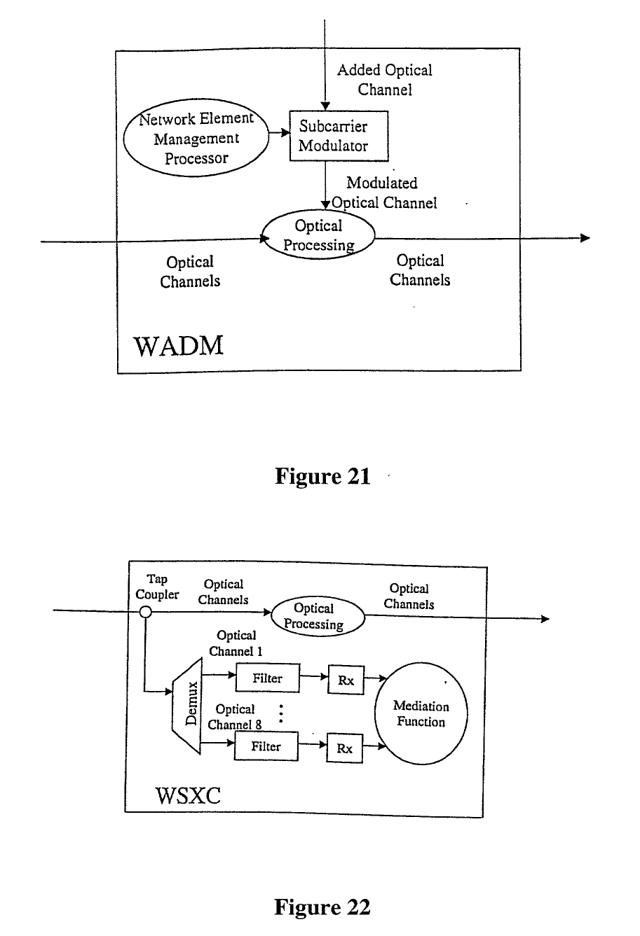

The upstream management signal is transmitted from a WADM as shown in FIG. 21. The WADM has an Optical Channel that is being added and routed to the WSXC. The upstream management signal is encoded to the SCM frequency, and the Optical Channel is amplitude modulated. The modulated Optical Channel is multiplexed with the other Optical Channels and is routed to the WSXC.

The WSXC receives the upstream management signal as shown in FIG. 22. The Optical Channel arrives at the left of the figure, and a small amount of the incoming signals is tapped off. The Optical Channels are demultiplexed from this tapped-off light, and the modulated Optical Channels are filtered to recover the individual subcarrier modulated signals. These are converted into electrical upstream management signals that are then routed to the mediation function. Note that the overmodulation remains on the affected Optical Channels until they are terminated (or 3R regenerated). With the low bit rates involved, sufficient power will reach the receivers.

In summary, the embodiment of the invention described above with reference to FIGS. 12-22 provides a management communication system among optical network elements arranged in a ring of nodes, where one ring node has a mediation device functionality. The mediation device function relays management messages as needed among the nodes and the network management system. The node with the mediation device functionality sends messages to the other ring nodes by broadcasting a single channel optical signal whose frequency is outside the transmission band of the Optical Channels. The other rings nodes each send messages to the node with the mediation device functionality by subcarrier modulation of an added Optical Channel. The structure of the message channel from the node with mediation device function to the other nodes (and vice versa) is logically or otherwise partitioned to allow messages from any source node (or NMS) to any sink node (or NMS).

Interconnection of Optical Channel Dedicated Protection Rings

With the advent of all-optical networking, there has been growing interest in using Optical Add-Drop Multiplexers (OADMs) to implement high capacity DWDM ring networks with add-drop functionality provided all-optically without any unnecessary O-E-O conversion for traffic passing straight through a node on the ring. One of the key functions of an OADM is to provide protection of the client signal. This means that the client signals can still be transmitted from the ingress node to the egress node even if a failure such as a fiber cut occurs within the ring network.

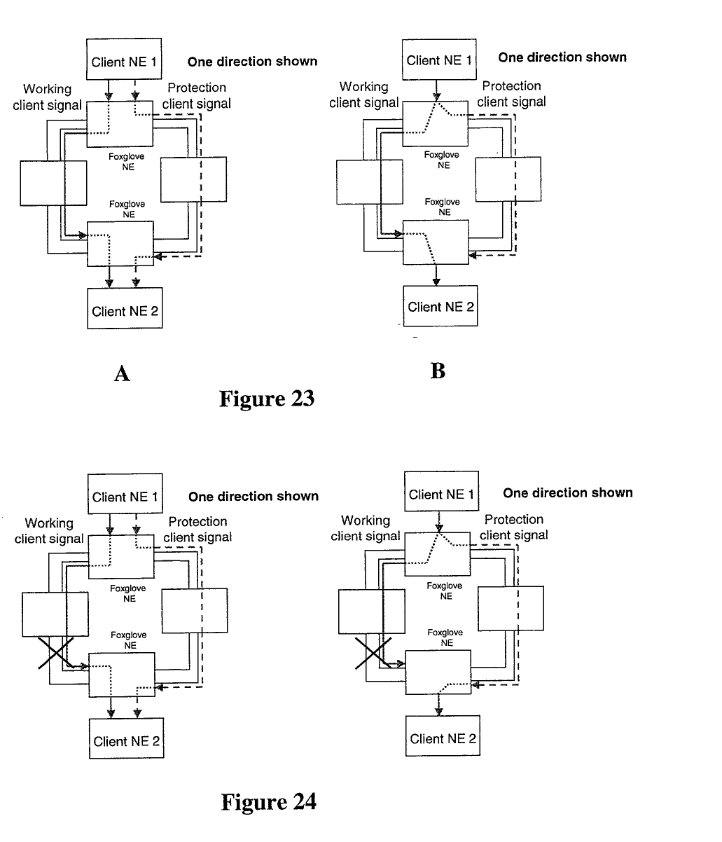

There are many different varieties of protection schemes, which will not be described in detail here. The simplest scheme to implement and most popular scheme for use in metropolitan networks, is known as Optical Channel Dedicated Protection Ring or OChDPRING. The basic principle of operation of an OChDPRING is illustrated in FIG. 23. Two fibers, each carrying traffic in opposite directions, are used to route traffic around the ring. Client signals entering the network at the ingress node are duplicated, routed in opposite directions around the ring over the two fibers, and one of the two optical signals is then selected at the receiver. One of these paths is designated ‘working’ and is the path normally used to transmit data, and the other path is designated ‘protection’ and only used if the working path fails. This is illustrated in FIG. 24.

The signal duplication at the ingress node, known as bridging, and the selection of one of the signals at the receiver, may be carried out in either by the OADM (FIG. 23B) or by the client itself (FIG. 23A).

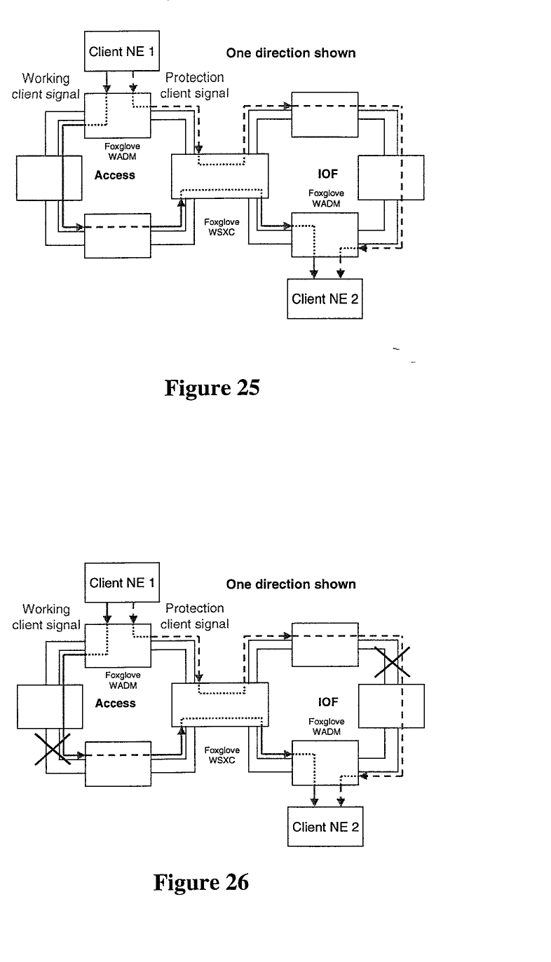

As such rings become more prevalent in metro networks, the need arises to interconnect rings to allow traffic to flow from one ring to another. One approach to doing this is the direct interconnection method, shown in FIG. 25. Here, the working path from one ring is connected to the working path on the other ring, and the protection path on one ring is connected to the protection path on the other ring. Such a scheme would survive a fiber cut in either ring. However, the protection of traffic on each ring would not be independent in the sense that whether or not a ring could heal from a failure would depend upon whether or not a failure exists in the other ring. This is illustrated in FIG. 26. If a failure occurs on the working path on one ring and the protection path of the other ring, the traffic is lost. This characteristic is highly undesirable and a better method of interconnecting rings while preserving the independence of the protection schemes on both rings is required.

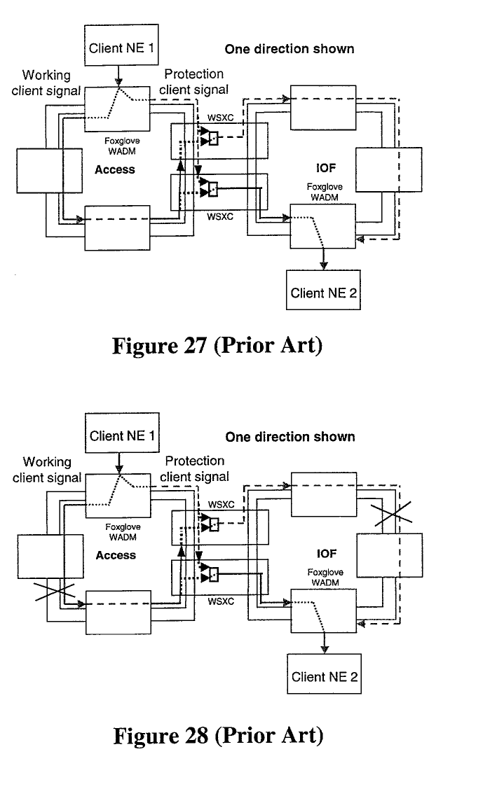

An alternative method of interconnecting rings using two interconnecting nodes is as shown in FIG. 27. This method may be referred to as the dual transmit with drop and continue method. The method preserves the independence of the protection schemes on each ring and also has no single point of failure. Two nodes are used to interconnect this ring and the working and protection signals are duplicated and sent to both nodes. 2×1 switches are then used at each node to select either of the working and protection signals from one ring for transmission onto the second ring. As shown in FIG. 28, this scheme maintains the connection for any combination of single failures in each ring.

However, this method has at least two significant drawbacks. First, two nodes are required to interconnect the rings. Although this is perfectly acceptable in long haul applications, metropolitan networks are far more cost sensitive and the use of two WSXC to interconnect rings is cost prohibitive. In addition, since the signal now has to propagate through an additional WSXC, the signal suffers additional loss, bandwidth narrowing and optical signal-to-noise ratio degradation. This limits the size of the network or increases the cost of the WSXC in order to minimize these degradations. (Note that the connection between the WSXCs is a multi-wavelength connection over a single fiber. Hence, the signals need to go through an additional stage of multiplexing, amplification and demultiplexing to go from one WSXC to the other.)

A low cost means of interconnecting two OChDPRINGs while preserving the independence of their protection schemes and minimizing the optical signal degradation is achieved by using a single interconnection node with a novel internal architecture to maintain the independence of the protection schemes.

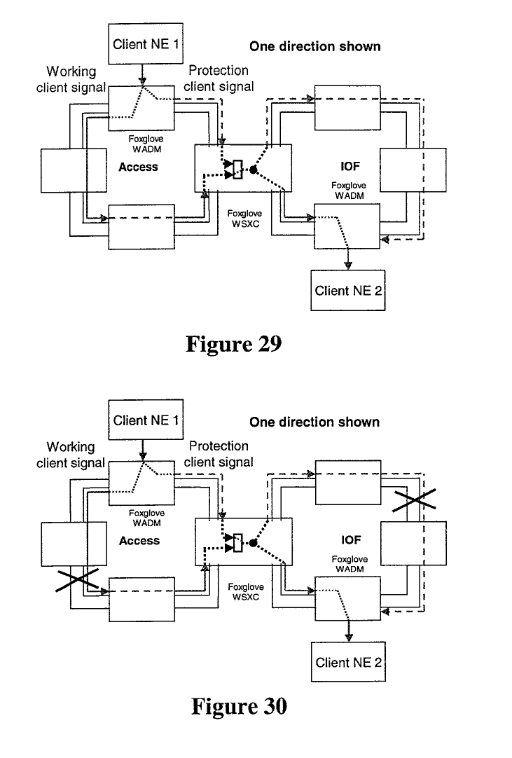

An example embodiment is shown in FIG. 29. Here, the interconnecting node selects the better of the two copies (working or protect) of the signal from the first ring and duplicates the signal for transmission onto the second ring. As shown in FIG. 30, this scheme maintains the connection for any combination of single failures in each ring.

However, this method has one drawback in that the selector and bridge at the interconnection node are a single point of failure. If either of these two components fails, the traffic will be lost.

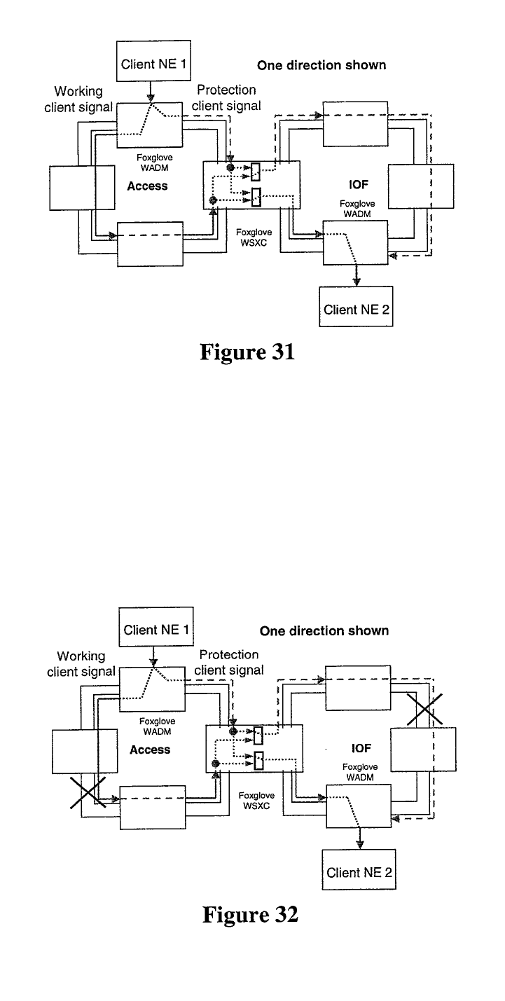

A second example embodiment avoids this single point of failure and is shown in FIG. 31. Here, both working and protection signals from the first ring are duplicated first, and then two 2:1 switches are used to select the better of the working and protect signals from ring 1, and transferred to the working and protect paths of the second ring. This method effectively provides protection for the bridge and switches in the interconnection node.

As can be seen in FIG. 32, the independence of the protection schemes on both rings is preserved, and there is no single point of failure in the path.

Improvement of Optical Network Ripple by Use of Narrow-band Amplifiers

The optical performance (noise figure and ripple) of a wavelength selective crossconnect (WSXC) can be improved by using a combination of wide-band optical amplifiers and narrow-band optical amplifiers.

Wavelength selective crossconnects (WSXC) are a critical element in all-optical wavelength division multiplexed networks. Interconnections between all various fiber rings occurs at the WSXC. The WSXC demultiplexes the wavelength channels carried on the input fibers, amplifies or regenerates them, then routes and multiplexes the signals destined for the same output fiber.

In all-optical wavelength division multiplexed networks, wavelength ripple (differences in loss/gain for the various wavelengths in the system) from the optical components in the WSXC creates a significant constraint on the performance of the network. It can limit both the size and the data rate of the system. The wavelength ripple arises from both passive and active components, but one of the most significant sources of ripple is the optical amplifiers in the system. For optical amplifiers, a major component of the ripple arises from the control of the gain of the amplifier, especially as individual wavelength channels are added or dropped from the system. The addition or removal of wavelength channels over a wide (30 nm) optical spectrum causes the optical amplifier to operate at non-ideal inversion levels, creating the wavelength ripple. Also, wavelength dependent variations in optical components such as taps (such as those that may be used to monitor power levels in the amplifier in order to provide feedback to the gain control mechanism) can also contribute to the difficulty in achieving precise gain control over a wide optical spectrum.

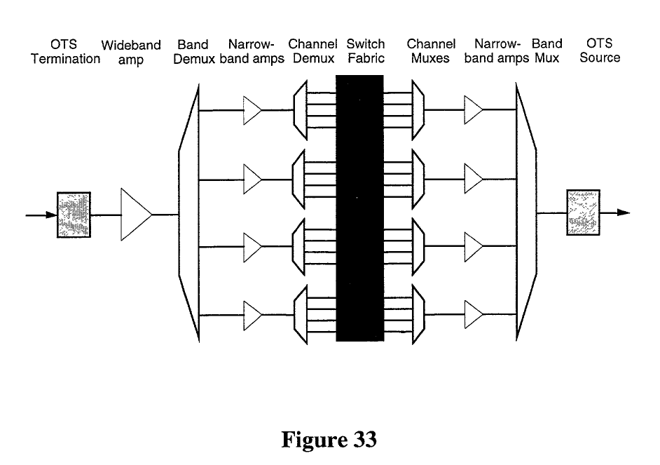

An improvement in optical performance of the WSXC can be achieved by employing a combination of wide-band and narrow-band optical amplifiers. FIG. 33 depicts the optical schematic for a WSXC with a combination of wide-band and narrow-band amplifiers. The optional OTS termination removes the OSC and any CDWM signals and, although FIG. 33 only shows the path for one band, the OMS signal could be split into C and L bands, or more. (The optical path for each band would be equivalent, so only one is shown here, for ease of illustration.) The signal then travels to the low-gain wide-band amplifier, through a band demux and to the narrow-band amplifiers. The bands are demuxed into their constituent wavelengths, the signals are switched to the appropriate output fibers (or added or dropped) and the wavelengths are multiplexed back into bands. The bands are amplified by an output narrow-band amplifier, and then muxed back together. Finally, the OSC is added to the OMS and the OTS is sent out on the output fiber.

The regime the amplifiers are operated in, and the bandwidth of each amplifier, are selected in light of the following considerations. Operating the first wide-band amplifier in an unsaturated regime (i.e., where the inversion is high and the output power is low so that the gain of the stage is relatively unaffected by small changes in the total signal power within the anticipated range of operation) provides essentially a fixed channel gain that is independent of the number of channels present in the band. Therefore, this amplifier requires little or no gain control, and the contribution to the overall amplifier ripple is minimal. The ripple of this amplifier is also small since the gain is relatively static, and can be reduced or controlled by conventional methods such as gain flattening filters (GFFs).

The narrow-band amplifiers provide gain for a smaller grouping of wavelengths, called sub-bands. In this example, the C (and/or the L) band is broken into 4 equally sized sub-bands, but in general, the C (and/or the L) band could be split up in any combination of sub-bands that individually have a narrower bandwidth than the C (or L) band. By reducing the bandwidth of the amplifier, there are two potential reductions in the ripple of the amplifier. First, the narrow bandwidth will intrinsically have less ripple than a wide-band amplifier due to the complex nature of the gain spectrum of the amplifier. Secondly, gain control of the narrow-band amplifier will be easier since there are fewer combinations of channels to consider for adding and dropping and also there is less intrinsic gain ripple. Furthermore, the typical gain control technique which utilizes the total signal power into and out of the amplifier works most accurately when all of the signals have nearly equal power. This allows the use of simpler control algorithms for the gain control for each of the sub-band amplifiers. Also, the wavelength variations of the feedback taps will be minimized since the wavelength range of their operation is reduced.

Another advantage of the narrow-band amplifiers is that the total output power needed is less than a wide-band amplifier because there are fewer channels in the amplifier. For example, if the wide-band amplifier supports 16 channels, then a narrow-band amplifier with only 4 channels has a total output power 6 dB less than the wide-band amplifier. This allows for less expensive pump lasers to be employed in the narrow-band amplifier.

Further, the pairs of narrow-band amplifiers (input and output) can use matched gain-flattening filters to reduce the ripple of the amplifier. Although matched GFFs are commonly used for wide-band amplifier pairs, they must cover a much wider range of wavelengths and therefore are more difficult and expensive to make, and may have reduced gain-flattening ability compared to a matched set of narrow-band GFFs. It may be advantageous in terms of manufacturing, however, to have only a limited set of GFFs that can be used in many different narrow-band amplifiers (i.e. the same narrow-band amplifier design could be used to amplify either sub-band 1 or sub-band 2).

There is a cost disadvantage to amplification on a narrow-band basis because of the need for the band demux and muxes as well as the duplication of components for the narrow-band amplifiers. However, in the case of a WSXC, the signal is being demuxed/muxed to a band level before the individual channel demux/muxes. Also, by operating on a band basis, the system is more modular and can be deployed on a per-band basis.

Modular and Efficient Partitioning of an Optical Cross Connect

Optical cross connects (OXCs) are an essential part of optical networks, which allow circuits (wavelength channels) to be provisioned across a network. OXCs are required to facilitate provisioning of circuits, protection and restoration of traffic, grooming, and bandwidth management. In order to do this, OXCs must be able to carry out multiple functions on each wavelength channel including signal amplification, multiplexing and demultiplexing of individual wavelength channels or bands, switching and routing of channels and channel power equalization.

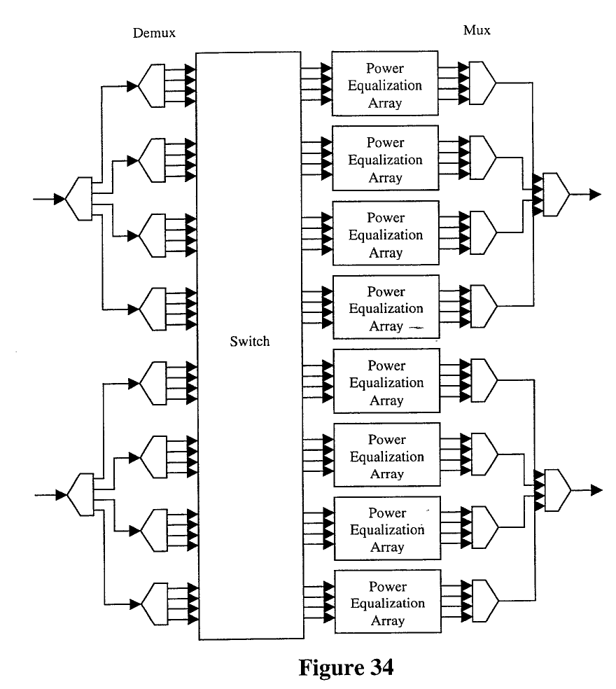

An example schematic of an OXC is shown in FIG. 34.

Due to the large numbers of channels and I/O ports, optical cross connects are large pieces of equipment typically occupying several racks or bays. However, network operators naturally desire that optical cross connects be modularly-upgradable so that only a small number of modules are needed to install the OXC initially with a few channel capacity, but allowing the OXC to be gracefully upgraded as more capacity (channels) are needed. This need for modular upgradability implies that the OXC design must be partitioned into modules which can then be added on an as-needed basis. Partitioning of the OXC into smaller modules which can be replaced individually is also necessary to provide the equipment reliability needed in the telecom industry since the overall system can be designed so that failed modules can be replaced without affecting other parts of the system.

Each of the functional elements shown in FIG. 34 may be formed and structured as an individually replaceable unit or module. Hence, the OXC would consists of a multitude of different types of circuit packs, each carrying out just one function on just one channel, or a small subset or band of channels. This, however, has multiple drawbacks. For example, each channel passes through a large number of optical taps as it enters and exits each replaceable unit—these taps are required to monitor the optical signal and to allow fault location down to the smallest replaceable unit, and these taps increase the loss along the signal path and add to cost. Further, since each functional unit may be replaced at any tine in the field, the OXC must be designed to operate with the worst case combination of losses for each path or, alternatively, multiple spares must be retained on-site by the user in order to ensure that the user has a module at hand of the appropriate loss in order to replace a failed unit and still maintain the same optical loss for the signal.

By an efficient and modular design of an optical cross connect, the optical path loss through the OXC can be reduced and further, the variability of this total loss between units in a manufacturing environment can also be reduced. If, instead of having the OXC partitioned by functionality, the OXC is partitioned along the optical path of each channel or band or channels, graceful channel-by-channel or band-by-band expansion characteristics can be maintained while minimizing the path loss through the OXC. This is achieved, at least in part, by: (a) minimizing the number of taps (which are needed at the input and outputs of each replaceable unit for localizing equipment faults); (b) increasing the scope for selective assembly to reduce the variation in signal path loss by putting more optical components on a single replaceable unit. Reducing the variability of the insertion loss is especially important in transparent optical networks since the loss within an OXC and the optical gain needed to compensate for this can an important factor which limits the size of optical network over which a purely optical signal can propagate without the need for electronic regeneration. Greater variability in the path loss typically requires that extra margin be left in the system (e.g. assuming a ‘worst case’ design in which all cross-connects are assumed to have a total loss which is well in excess of the sum of the average losses of the individual components). Thus, reducing the variability of the loss can be as important as reducing the loss itself.

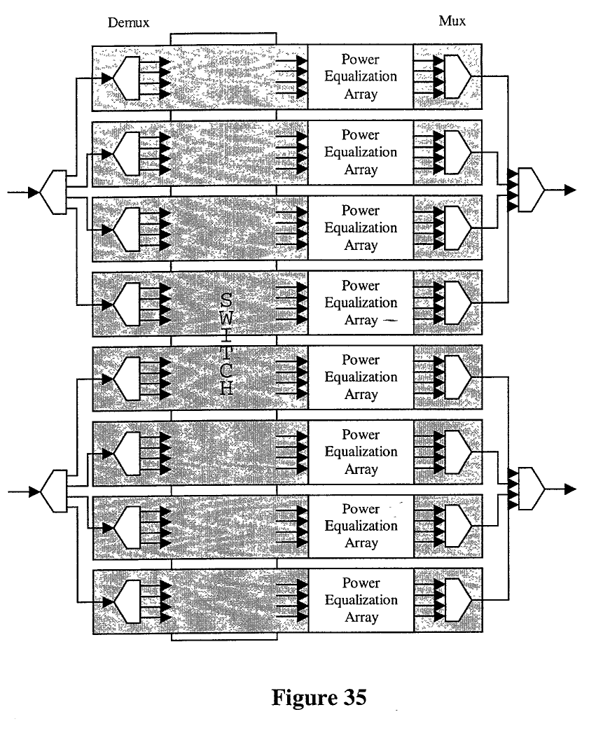

An embodiment of this aspect of the invention is shown in FIG. 35. Here, the mux/demux, switching and power equalization function for each wavelength band has been integrated into a single module. Now, optical taps are only required at the input and output of module and not before and after each functional element. This reduces the loss seen by each wavelength channel.

In addition, since the module now contains multiple components in the same signal path, selective assembly can be used to reduce the variation in signal path loss through the OXC. Variations in signal path loss have an effect similar to that of amplifier gain ripple and can significant limit the number of OXCs that can be cascaded in a network. Selective assembly refers to the selection of optical components used in each optical path in such a manner so as to reduce the variation in path loss. Thus, for example, the components to be used in the assembly/manufacture of the modules would be sorted by insertion loss within each different type of component. Power equalization units with above average loss could then be used with mux/demuxes with below average loss and vice versa. Note that without integrating these functions onto a single replaceable unit, selective assembly becomes very difficult to do. Since new functional elements would be added and replaced in the field, an equipment manufacturer would potentially have little control over the relative loss of different components that were installed in a particular signal path after manufacture.

In the past, conventional wisdom has counseled against such an approach, at least in part because of reliability requirements. Grouping multiplexers or demultiplexers with other components means that a failure of any of the single components requires an interruption (e.g., a protection switch) of all of the channels that pass through that module (i.e., the whole band the uses the same MUX/DEMUX). This problem has been mitigated by a number of recent developments. The cost of optical components has dropped so that they are now used in less-heavily-shared parts of the network (where fewer users' signals are combined or multiplexed together to amortize equipment cost), and thus reliability requirements are not as extreme. Also, the growing experience with optical components has shown that they are reliable enough to be combined.

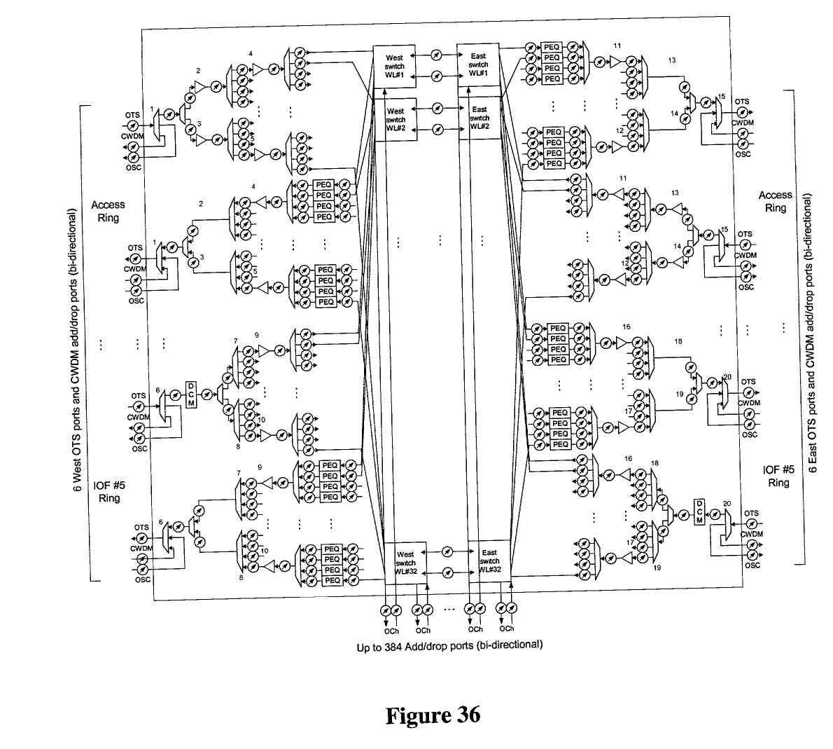

Another example embodiment using this partitioning is shown in FIG. 36. In this example, the OXC has been partitioned to separate East and West ports. This is required to prevent a single point of failure when the OXC is used with a 2FBLSR SONET protection scheme. The example also shows optical amplification on a per-band basis incorporated onto the same modules as the optical channel mux/demux. Similarly, the power equalization function is integrated with the optical channel multiplexing function. In this example, the optical switching function has not been integrated into the mux/demux modules.

Although the embodiments described above relate to a wavelength selective cross connect (i.e. one without the ability to perform wavelength conversion), the invention also applies to wavelength interchanging cross connects (i.e. ones with wavelength conversion capabilities).

Method for Control of Ripple Compensation for a WSXC

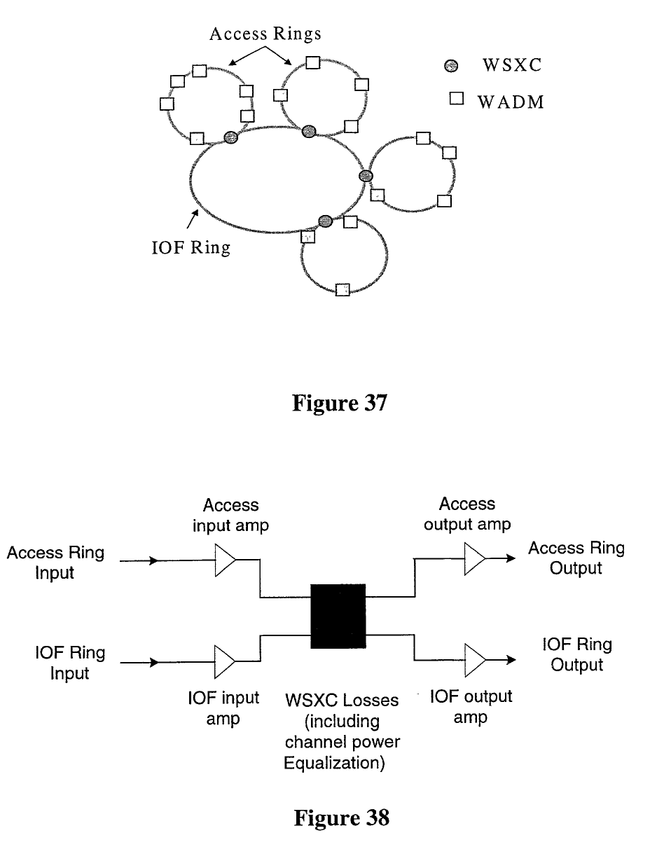

Wavelength selective cross-connects (WSXC) are a critical element in all-optical wavelength division multiplexed networks. Interconnections between all various fiber rings occurs at the WSXC. The WSXC demultiplexes the wavelength channels carried on the input fibers, amplifies or regenerates them, then routes and multiplexes the signals destined for each output fiber. FIG. 37 shows an example optical network with an IOF (Inter-office) ring and several access rings.

In all-optical wavelength division multiplexed networks, wavelength ripple (differences in loss/gain for the various wavelengths in the system) from the optical components in the network creates a significant constraint on the performance of the network. It can limit both the size and the data rate of the system. The wavelength ripple arises from both passive and active components, both internal and external to the WSXC. Therefore, the total ripple for the different paths through the WSXC may vary due to the differences in the ripple external to the WSXC.

One way to compensate ripple in the WSXC is by individual channel power equalization (PEQ). The typical method for channel PEQ is via a variable optical attenuator (VOA) on the demultiplexed signal that is controlled by a feedback loop. The attenuator is set to some nominal attenuation value, and then the ripple in the system is corrected by either increasing or decreasing the loss of the VOA. But this method has a disadvantage in that all paths in the WSXC (i.e., IOF to IOF, Access to IOF, IOF to IOF, and Access to IOF) all have the same nominal attenuation value of the VOA, and suffer the accompanying performance penalties.

As an alternative, ripple can be compensated by (1) increasing the gain of the input amplifier as necessary so that the weakest channel has a minimum targeted power level, and (2) using individual channel power equalization to make all the channels have a flat spectrum at the output of the WSXC.

A simplified example schematic of the amplifiers and the signal paths for a WSXC which connects an access ring and an IOF ring is depicted in FIG. 38. The amplifiers shown are representative of total amplification on each path, and each may actually consist of several discrete amplifiers. The input spectrum of the signals from the IOF ring is considered to be flat, since the last optical node the signals traveled through was another WSXC that had power equalization. The signals from the access ring are initially calibrated at system deployment to provide a flat input spectrum at the WSXC. However, over time, the signals could have significant power divergence due to aging in components or changes in the access ring after initial deployment and calibration.

The gains on the input amplifiers are increased so that the input channel with the lowest power is amplified to some necessary minimum power at the input of the multiplexor stage of the WSXC. The channel power equalization then attenuates all the other signals to the appropriate levels to provide a flat signal spectrum at the output of the WSXC. Since the input ripples may be different, the amount the amplifier gain is increased will vary depending on the path. Take, for example, a case where the channel that has the least gain internal to the WSXC happens to be the channel that also has the lowest input power from the access ring. The access ring amplifier would increase its gain until that channel met some minimum power level at the input to the multiplexor, and all the other channels from that path would be attenuated by the PEQ to the appropriate power levels so that the output of the WSXC would be flat. The signals that were from the IOF would not be affected by the input ripple of the access ring, and would not suffer any resultant PEQ from to correct for that ripple. The IOF would have its own gain levels and PEQ levels to correct for any ripple on its path.

It is important to note that the amplification on any stage of the WSXC could consist of stages of discrete amplifiers, so that the gain increase of the input amplification stage could be performed in any combination of the gains and power levels of the discrete amplifiers. In the case of band amplifiers, it would be a cost advantage to adjust the gain of a wide-band amplifier rather than a larger number of narrow-band amplifiers. Also, note that any the gain compensation for external ripple could be used on only one of the two paths for the WSXC, or could still be used in combination with a nominal PEQ set-point method or any other standard control method of ripple compensation.

As will be understood by those of skill in the art, the foregoing aspects and embodiments of the present invention may be used in cooperation with each other as desired in various combinations and sub-combinations to provide improved transparency, flexibility, and performance in optical networks. The foregoing is also illustrative of the invention only, and various modifications will be apparent to those of skill in the relevant art. Accordingly, the invention is not limited to the foregoing exemplary embodiments, but includes all subject matter within the legal scope of the following claims.

We claim:

1. A wavelength selective optical cross-connect device comprising:
a. a first demultiplexor arranged to demultiplex an incoming signal;
b. a plurality of individually removeable modules, each module arranged to receive an output of the first demultiplexor and each including at least an optical switch for switching said output of the first demultiplexor.

2. The device of claim 1 further comprising a first multiplexor arranged to receive a respective outgoing signal from said each module of the plurality of individually removeable modules and to provide a multiplexed outgoing signal from the device.

3. The device of claim 2 wherein said each module further includes a respective second multiplexor arranged to pre-multiplex said respective outgoing signal before the first multiplexor.

4. The device of claim 3 wherein said each module further includes a power equalization array arranged to equalize the power of a respective outgoing signal from said each module.

5. The device of claim 1 wherein said each module further includes a respective second demultiplexor arranged to further demultiplexing said output of the first demultiplexor.

6. The device of claim 1 wherein said each module further includes a power equalization array arranged to equalize the power of a respective outgoing signal from said each module.

7. The device of claim 6 wherein said power equalization array is arranged to equalize the power of respective outgoing signal from each said module with respect to the power of respective outgoing signals other modules of said plurality of modules.

8. The device of claim 6 wherein said power equalization array comprises an amplifier for each of multiple wavelength channels for each module.

9. The device of claim 6 wherein said power equalization array comprises a variable attenuator for each of multiple wavelength channels for each module.

10. The device of claim 1 further comprising an optical protection switch separate from said optical switch.

11. A wavelength selective optical cross-connect device comprising
a. a first demultiplexor arranged to demultiplex an incoming signal;
b. a first multiplexor arranged to provide an outgoing signal; and
c. a plurality of individually removeable modules, each module arranged to receive a respective output of the first demultiplexor and feed a respective output of said module into said first multiplexor, each module including at least (i) a second demultiplexor arranged to further demultiplex the respective output of the first demultiplexor, (ii) a power equalization matrix arranged to equalize the power in channels from the second demultiplexor, and (iii) a second multiplexor arranged to pre-multiplex the channels from the second demultiplexor to form the output of said module.

12. The device of claim 11 further comprising one or more switch fabrics arranged to switch channels within one or more of the modules.

13. The device of claim 12 wherein said one or more switch fabrics are removable from the device and replaceable within the device.

14. The device of claim 13 wherein said one or more switch fabrics include a manual switch fabric with automated connection discovery.

15. The device of claim 14 wherein the manual switch fabric is a patch panel with electrical leads in the fiber patch cords arranged for automated connection discovery.

16. The device of claim 14 wherein said manual switch fabric includes one or more interfaces with the rest of the device that are identical or compatible with an interface employed by a switch fabric having remote or automatic reconfigurability, such that the device is readily upgradeable to a switch fabric having reconfigurability.

17. The device of claim 13 wherein the one or more switch fabrics include two or more switch fabrics separately and individually removeable.

18. The device of claim 13 wherein the one or more switch fabrics include two or more switch fabrics separately and individually upgradeable.

19. The device of claim 13 wherein the one or more switch fabrics include one manually reconfigurable switch fabric and one remotely reconfigurable switch fabric.

20. The device of claim 12 further comprising one or more protection switches separate from said one or more switch fabrics.

21. A wavelength add-drop module device for receiving network management messages or commands from a network management controller transmitted with communications traffic via a fiber connection, the device comprising a tap on the signal from an incoming fiber connection and a receiver arranged to detect signals on the tap.

22. The device of claim 21 further comprising a demultiplexor on the tap before the receiver.

23. The device of claim 21 further comprising a subcarrier modulator for sending device messages to the network management function.

24. The device of claim 23 wherein the subcarrier modulator is positioned and arranged to modulate the signal on optical channel added at the device.

25. A wavelength selective optical cross-connect device for providing ring or network management, the device comprising subcarrier demodulator for receiving messages from one or more wavelength add-drop modules on the associated ring or network, and a transmitter for transmitting messages at a selected wavelength to said modules.

26. The device of claim 25 further comprising a controller for performing monitoring and control functions for the device and for said one or more wavelength add-drop modules.

27. The device of claim 25 further comprising a tap arranged to provide a portion of an incoming signal to the subcarrier demodulator.

28. The device of claim 27 further comprising a demultiplexor arranged to demultiplex the tapped portion of the incoming signal.

29. The device of claim 28 further comprising multiple filters arranged to filter the demulitplexed signals from the tapped portion of the incoming signal.

30. A method of providing for communications for ring or network management in an optical fiber network that is at least in part ring-based, the method comprising:
providing at least one wavelength selective cross-connect on a ring in the network, the cross-connect including a controller or mediation function and at least one transmitter arranged to transmit on a network communications frequency and a subcarrier demodulator;
providing one or more wavelength add-drop modules connected to said ring and each including a subcarrier modulator for sending signals to said subcarrier demodulator;
sending control messages from the controller to the one or more wavelength add-drop modules via the transmitter on the a network communications frequency;
receiving said control messages from the controller in the one or more wavelength add-drop modules;
sending messages from the one or more wavelength add-drop modules to the controller via subcarrier modulation; and
receiving and decoding said messages from the one or more wavelength add-drop modules via subcarrier demodulation.

31. The method of claim 30 wherein the step of sending messages from the one or more wavelength add-drop modules to the controller via subcarrier modulation comprises modulating a different optical channel with each of said one or more wavelength add-drop modules.

32. The method of claim 30 wherein the step of sending messages from the one or more wavelength add-drop modules to the controller via subcarrier modulation comprises modulating at a different subcarrier frequency at each of said one or more wavelength add-drop modules.

33. The method of claim 32 wherein the step of sending messages from the one or more wavelength add-drop modules to the controller via subcarrier modulation comprises modulating a different optical channel at a different subcarrier frequency with each of said one or more wavelength add-drop modules.

34. The method of claim 30 wherein the step of receiving said control messages from the controller in the one or more wavelength add-drop modules comprises tapping a portion of the incoming signal at each of said one or more wavelength add-drop modules.

35. The method of claim 34 wherein the step of receiving said control messages from the controller in the one or more wavelength add-drop modules further comprises demultiplexing the network communications frequency from the tapped portion of the incoming signal.

36. The method of claim 30 wherein the step of receiving said control messages from the controller in the one or more wavelength add-drop modules comprises detecting logically instructions that are directed to a receiving one of the one or more wavelength add-drop modules and processing said instructions.

37. The method of claim 30 wherein the step of receiving and decoding said messages from the one or more wavelength add-drop modules via subcarrier demodulation includes using a digital signal processor to separate and decode the messages.

38. A wavelength selective optical cross-connect device comprising:
a pair of wavelength-layered cross-connect switch fabrics, the pair of fabrics being connectively surrounded by one-by-two switches so arranged as to be able to switch any input or output associated with the fabrics from one of the pair of fabrics to the other of the pair of fabrics to a provide protection switching function, while the fabrics are arranged provide path switching function.

39. A method of providing protection switching and path switching in a wavelength selective optical cross-connect device, the method comprising:
employing one-by-two switches to selectively connect input and output wavelength channels to either of two wavelength-layered cross-connect fabrics to provide a protection switching function; and
employing said two wavelength-layered cross-connect fabrics to provide a path switching function.

40. A wavelength selective cross-connect device for interconnecting two or more fiber rings, the device comprising a first optical switch arranged and positioned so as to be able to selectively connect a first loop of a first ring to either a first loop of a second ring or a second loop of the second ring; and a second optical switch arranged and positioned so as to be able to selectively connect a second loop of the first ring to either the first loop of the second ring or the second loop of the second ring.

41. The device of claim 40 wherein the first and second optical switches are one-by-two optical switches.

42. A wavelength selective optical cross-connect device comprising an input signal path including, in order, a wide band amplifier, a first demultiplexor, and a plurality of narrow band amplifiers arranged in parallel.

43. The device of claim 42 further comprising respective second demultiplexors following said narrow band amplifiers.
